(19) United States
(12) Patent Application Publication
(10) Pub. No.: US 2023/0147588 A1
(43) Pub. Date: May 11, 2023

(54) USE OF1,9-DECANEDIOL IN INHIBITING AMMONIA VOLATILIZATION FROM SOIL

(71) Applicant: INSTITUTION OF SOIL SCIENCE, CHINESE ACADEMY OF SCIENCES, NANJING (CN)

(72) Inventors: WEIMING SHI, NANJING (CN); MINGKUN MA, DUNHUA (CN); YUFANG LU, NANJING (CN)

(21) Appl. No.: 17/880,553

(22) Filed: Aug. 3, 2022

(30) Foreign Application Priority Data
Nov. 6, 2021 (CN) 2021113096731

(51) Int. Cl. C05G 3/90; C05C 9/00

(52) U.S. Cl. CPC C05G 3/90; C05C 9/00

(57) ABSTRACT

A use of 1,9-decanediol in inhibiting ammonia volatilization from soil is provided. It is found that 1,9-decanediol has dual regulation effects, not only significantly inhibiting ammonia volatilization from soil, but also effectively inhibiting nitrification process, which plays synergistic effects. As a fat-soluble substance, 1,9-decanediol has high stability in soil and is not easy to be separated from nitrogen fertilizer. 1,9-decanediol, as a plant root exudate, also has advantages of being green, safe, and pollution-free, which provides a new method and an idea to expand an application field of 1,9-decanediol and improve an industrial application value of 1,9-decanediol.

### TECHNICAL FIELD

The disclosure relates to the research field of nitrogen fertilizer synergists, and more particularly to a use/application of 1,9-decanediol in inhibiting ammonia volatilization from soil.

### BACKGROUND

When a nitrogen fertilizer is applied to soil, the nitrogen fertilizer can be rapidly converted into ammonia nitrogen under an action of urease, the ammonia nitrogen is converted into nitrate nitrogen under an action of nitrification, and the nitrate nitrogen is converted into nitric oxide (NO), nitrous oxide (N₂O), and nitrogen (N₂) under an action of denitrification; and accumulation of the ammonia nitrogen in the soil would cause increase of pH value of the soil, which will convert the ammonia nitrogen into ammonia and volatilized into the air. These ways make the utilization rate of nitrogen fertilizer per season only to 35%-39%. Among them, loss of ammonia volatilization in farmland can reach to 20%-47% of the amount of nitrogen application. Therefore, reducing ammonia volatilization is an important measure to improve nitrogen utilization rate of paddy fields and reduce environmental pollution.

At present, the key to reducing ammonia volatilization in farmland is how to optimize the effectiveness of urea-containing fertilizers. The main measure is to apply nitrogen fertilizer synergists, such as inhibitors N-(N-butyl)-thiophosphoric triamide (NBPT), hydroquinone (HQ), p-phenylenediamine (PPD) and so on, to the soil, which can significantly reduce ammonia volatilization from the soil. However, these inhibitors are chemically synthesized and have a great impact on the environment. Therefore, screening biological inhibitors from nature is a new green and efficient way. Researchers have extracted alginate from algae as a nitrogen fertilizer synergist and found that the alginate plays a good role in inhibiting ammonia volatilization from the soil (with reference to the Chinese Patent Application No. 201510132551.8, corresponding to Publication No. CN104761413A). Although the alginic acid as a natural substance has less environmental pollution, the extraction process of the alginic acid is complex and the production cost is high, which is not conducive to widespread application.

1,9-decanediol is a fat-soluble biological nitrification inhibitor found by the inventor in an early stage from root exudates of paddy rice, which can inhibit the nitrification process at low concentration and reduce nitrogen loss (with reference to the Chinese Patent Application No. 201510926728.1, corresponding to Publication No. CN105439782A). However, the application of 1,9-decanediol in inhibiting soil ammonia volatilization has not been disclosed. Screening plant-derived functional substances that simultaneously inhibit ammonia volatilization and nitrification will greatly promote the research and development of new green and efficient nitrogen fertilizer products, which have important practical significance in agriculture.

### SUMMARY

Technical problems to be solved: aiming at the problems existing in the related art, the disclosure provides a use of 1,9-decanediol in inhibiting ammonia volatilization from soil, achieving effects of reducing nitrogen loss, reducing environmental pollution, improving utilization rate of nitrogen fertilizer, and further expanding industrial application field of 1,9-decanediol.

Technical solutions: in an aspect, a use of 1,9-decanediol in inhibiting ammonia volatilization from soil is provided.

In an embodiment, an addition amount of 1,9-decanediol in soil is in a range of 100 micrograms per kilogram (mg/kg) to 1000 mg/kg.

The 1,9-decanediol and urea are prepared into a mixed solution, and the mixed solution is applied to soil.

In another aspect, a use of 1,9-decanediol in preparing a product for inhibiting ammonia volatilization is provided.

Beneficial effects:
in one aspect, the dual regulation of 1,9-decanediol is found, which can not only effectively inhibit the nitrification process of nitrogen fertilizer, but also significantly inhibit the ammonia volatilization from soil, further broaden the application field of 1,9-decanediol, and improve the industrial application value of 1,9-decanediol;
in another aspect, 1,9-decanediol is single molecule with multiple functions, which can replace other inhibitors in the preparation of stable fertilizers, reduce types of inhibitors, and further reduce the potential threat to the environment caused by the addition of multiple synergists; and
in still another aspect, 1,9-decanediol, as a plant root exudate, has the advantages of being green, safe, and pollution-free; and 1,9-decanediol, as a fat-soluble substance, has high stability in soil and is not easy to be separated from nitrogen fertilizer.

### BRIEF DESCRIPTION OF DRAWINGS

FIG. 1 illustrates a schematic diagram of an experimental soil column.

FIG. 2 shows cumulative amounts of ammonia volatilization from soil corresponding to different additions of 1,9-decanediol.

FIG. 3 shows cumulative amounts of ammonia volatilization from soil treated with different inhibitors.

### DETAILED DESCRIPTION OF EMBODIMENTS

Embodiment 1:1, 9-decanediol and urea are prepared into a mixed solution to be applied to soil. Among them, an addition amount of 1,9-decanediol in soil is 100 micrograms per kilogram (mg/kg).

Embodiment 2:1, 9-decanediol and urea are prepared into another mixed solution to be applied to soil. Among them, an addition amount of 1,9-decanediol in soil is 200 mg/kg.

Embodiment 3:1, 9-decanediol and urea are prepared into still another mixed solution to be applied to soil. Among them, an addition amount of 1,9-decanediol in soil is 500 mg/kg.

Embodiment 4:1, 9-decanediol and urea are prepared into a mixed solution to be applied to soil. Among them, an addition amount of 1,9-decanediol in soil is 1000 mg/kg.

### Test Example 1: Effects of 1,9-Decanediol on Ammonia Volatilization From Soil

### 1. Experimental Design

1.1 test soil: the test soil type is paddy soil, and the texture is sandy loam. It is collected from 0~20 centimeters (cm) topsoil of the experimental field in Yingtan City, Jiangxi Province (28°15′N, 116°55′E), sieved with a 2 millimeters (mm) sieve, and mixed evenly. See Table 1 for basic physical and chemical properties.

TABLE 1

physical and chemical properties of soil

| pH | Total nitrogen (g/kg) | NH₄⁺—N (mg/kg) | NO₃^{—}—N (mg/kg) | Organic matter (g/kg) |
|---|---|---|---|---|
| 5.06 | 0.92 | 9.94 | 7.49 | 16.6 |

### 1.2 Test Reagent: 1,9-decanediol (C₁₀H₂₂O₂)

1.3 experimental treatment: urea treatment (U) and 1,9-decanediol + urea treatment are set in experiments. Among them, 1, 9-decanediol is added in soil at four levels of 100 mg/kg, 200 mg/kg, 500 mg/kg, and 1000 mg/kg, numbered as: 1, 9-D-100, 1, 9-D-200, 1, 9-D-500, and 1, 9-D-1000 respectively. Each treatment is repeated three times. The nitrogen application rate is 200 mg nitrogen per kilogram soil.

### 1.4 Experimental Steps

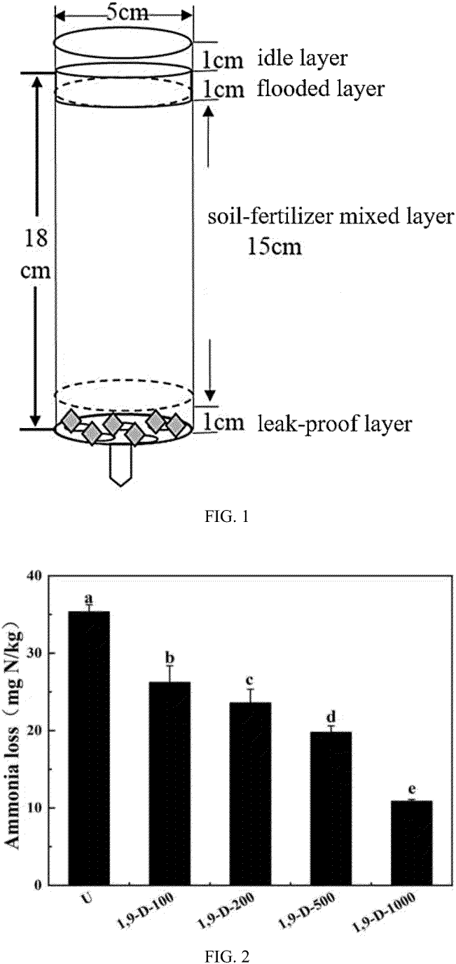

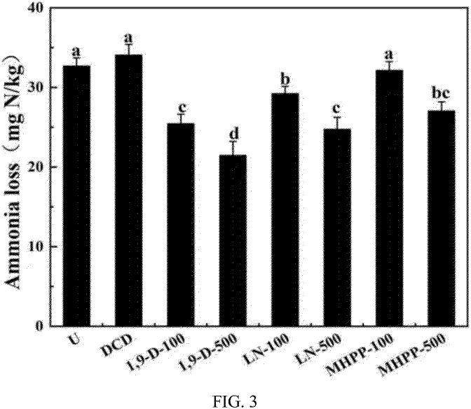

A soil column culture method is used for the test (FIG. 1). The soil column is 18 centimeters (cm) in height and 5 cm in inner diameter, which is divided into a leak-proof layer, a soil-fertilizer mixed layer, a flooded layer, and an idle layer (also referred to as spare layer). A leak-proof pad and 1 cm thick quartz sand are placed in the leak-proof layer at a bottom of the soil column firstly to prevent soil leakage and simulate a real situation in the field, and then the experimental soil is added to the soil-fertilizer mixed layer, and after compaction, a bottom leaching switch is turned on and water is added to restore the soil activity. After one night of soil recovery activity, the bottom leaching switch is turned off, and the urea required for each treatment is mixed with 1,9-decanediol to prepare a mixed solution. The mixed solution is evenly applied to the soil-fertilizer mixture layer of the soil column, the water is added to maintain a flooded state, and the ammonia volatilization from soil is monitored for 21 consecutive days.

### 1.5 Experimental Results

Compared with the treatment (U) without 1,9-decanediol, the application of 1,9-decanediol can significantly reduce the total amount of ammonia volatilization from soil, and the inhibition effect of ammonia volatilization is more obvious with the increase of the dosage of 1,9-decanediol (as shown in FIG. 2).

### Test Example 2: Effects of Different Inhibitors on Ammonia Volatilization From Soil

### 2.1 Test Soil: The Same as Test Example 1

2.2 test reagent: 1, 9-decanediol, the same as test example 1, dicyandiamide (DCD, C₂H₄N₄), linolenic acid (LN, C₁₂H₃₀O₂) and methyl 3-(4-hydroxyphenyl)propionate (MHPP, C₁₀H₁₂O₃) are purchased from Sigma.

2.3 experimental treatments: urea treatment (U), DCD + urea treatment, LN + urea treatment, MHPP + urea treatment, and 1,9-decanediol + urea treatment are set in experiments, in which an addition of DCD in soil is 20 mg/kg, and additions of LN, MHPP and 1,9-decanediol in soil each includes 100 mg/kg and 500 mg/kg, numbered as: DCD, LN-100, LN-500, MHPP-100, MHPP-500, 1,9-D-100, and 1,9-D-500. Each treatment is repeated three times. The nitrogen application rate is 200 mg nitrogen per kilogram soil.

### 2.4 Experimental Steps: The Same as the Test Example 1

### 2.5 Experimental Results

Compared with the urea treatment (U), the application of 1,9-decanediol, LN, and MHPP with different additions (100 and 500 mg/kg) can inhibit ammonia volatilization from soil. Among them, the ammonia volatilization from soil treated with 1,9-decanediol is significantly lower than that from soil treated with LN and MHPP. The inhibition effects of ammonia volatilization from high to low are: 1,9-D-500 > LN-500 > 1,9-D-100 >MHPP-500 > LN-100 > MHPP-100.

1. A use of 1,9-decanediol, comprising:
preparing a mixed solution based on the 1,9-decanediol and urea; and
applying the mixed solution to soil containing urease, and the 1,9-decanediol of the mixed solution acting as an inhibitor of the urease to reduce a conversion of the urea to an ammonia nitrogen and thereby reduce ammonia volatilization from the soil.

2. (canceled)

3. The use according to claim 1, wherein an addition amount of the 1,9-decanediol in the soil is in a range of 100 micrograms per kilogram (mg/kg) to 1000 mg/kg.

4-5. (canceled)
